(19) United States
(12) Patent Application Publication
(10) Pub. No.: US 2010/0312437 A1
(43) Pub. Date: Dec. 9, 2010

(54) CONSTRUCTION MACHINE

(75) Inventor: Yoshiaki Saito, Saitama (JP)

Correspondence Address: POSZ LAW GROUP, PLC, 12040 SOUTH LAKES DRIVE, SUITE 101, RESTON, VA, 20191, US

(73) Assignee: KOMATSU LTD., Tokyo (JP)

(21) Appl. No.: 12/735,653

(22) PCT Filed: Jan. 26, 2009
(86) PCT No.: PCT/JP2009/000283

§ 371 Date: Aug. 5, 2010

(30) Foreign Application Priority Data
Feb. 20, 2008 (JP) 2008-038351

(51) Int. Cl. G06F 19/00

(52) U.S. Cl. 701/50

(57) ABSTRACT

A construction machine assists loading work and alleviates the burden upon the operator. This construction machine is provided with: a boom lever that can assume a position for commanding raising of a boom, a position for commanding lowering thereof, and a position for commanding a neutral state; a bucket lever that can assume a position for commanding a bucket to be tilted, a position for commanding dumping, and a position for commanding a neutral state; and a controller for detecting the positions of the boom lever and the bucket lever, and for controlling the boom and the bucket according to these detected positions. When the boom lever is set to the position for commanding raising of the boom and the boom is being moved upwards, if the controller detects that a predetermined operation is performed with the boom lever, then the controller causes the bucket to be dumped.

### CROSS REFERENCE TO RELATED APPLICATIONS

This application is a U.S. national stage application of PCT/JP2009/000283 filed on Jan. 26, 2009, and claims priority to, and incorporates by reference, Japanese Patent Application No. 2008-038351 filed on Feb. 20, 2008.

### TECHNICAL FIELD

The present invention relates to a technique for controlling a construction machine, and in particular relates to a technique for assisting an operator while he is performing loading work using a construction machine.

### BACKGROUND

Operation levers are provided in the operator chamber of a construction machine, and the construction machine is operated by the operator actuating these operation levers. For example, in the case of a construction machine like a wheel loader or the like which has a boom and a bucket which is fitted at the end of the boom, there is a type in which an operation lever for the boom and an operation lever for the bucket are provided separately, and also a type in which a single lever (a “mono-lever”) is provided that can actuate either one of the boom and the bucket. A construction machine of the mono-lever type is, for example, described in Patent Document #1.

Patent Document #1: Japanese Laid-Open Utility Model Publication No. 5-57039.

Now, the task which is performed by a wheel loader is to repeat excavation work and the work of loading material that has been excavated. In particular, in the case of a large size wheel loader, it is often the case that the working time becomes long, so that the burden imposed upon the operator is great. Thus there is a type of wheel loader in which, in order to alleviate the burden upon the operator, a portion of the operation of the boom and the bucket is automated by providing a semi-automatic excavation mode for assisting the work of excavation.

However, since no control for assisting loading work is performed even if a semi-automatic excavation mode is provided, therefore, according to all prior art, it has been necessary for the operator to perform operation in order for loading work to be accomplished.

### SUMMARY

Thus, the objective of the present invention is to aid with loading work, and to alleviate the burden upon the operator.

The construction machine according to an embodiment of the present invention is a construction machine comprising a boom and a bucket fitted to said boom, and comprises: a boom operation lever that can be positioned to a position that commands elevation of said boom, a position that commands lowering thereof, and a position that commands neutral; and a controller that detects the position of said boom operation lever, and controls said boom and said bucket according to this detected position; wherein, while causing said boom to be elevated, when said controller has detected that a predetermined actuation of said boom operation lever has been performed, then said controller performs control so as to cause said bucket to be dumped.

In a preferred embodiment, it would also be acceptable to arrange for said controller, after having caused said bucket to be dumped, when said controller detects that said boom operation lever has been actuated to said position that commands lowering of said boom, to perform control so as to cause said bucket to be tilted.

In a preferred embodiment, it would also be acceptable to arrange for there to be further included a bucket operation lever that can be positioned to a position that commands tilting of said bucket, a position that commands dumping thereof, and a position that commands neutral; and for said controller to detect the position of said bucket operation lever and to control said bucket according to this detected position, and, while control of said bucket is being performed on the basis of actuation of said boom operation lever, when said controller has detected that said bucket operation lever has been actuated, for said controller to stop the control of said bucket on the basis of actuation of said boom operation lever.

And, in a preferred embodiment, it would also be acceptable to arrange for there to be further included a sensor which detects that dumping of said bucket has been completed; and, when said controller detects, according to the output of said sensor, that said bucket has reached a dumping completed position, for said controller to perform control so as to cause said bucket to reciprocate between said dumping completed position and another predetermined position.

### BRIEF DESCRIPTION OF DRAWINGS

FIG. 1 is a block diagram of a control system provided to a construction machine according to an embodiment of the present invention;

FIG. 2 is a figure showing the positional relationship of the boom and the bucket with relation to the ground surface (the horizontal plane);

FIG. 3 is a flow chart showing the processing sequence of the semi-automatic loading function according to this embodiment; and

FIG. 4 is a further flow chart showing the processing sequence of the semi-automatic loading function according to this embodiment.

### DETAILED DESCRIPTION

A construction machine according to an embodiment of the present invention, such as a wheel loader or the like, is provided with a boom and with a bucket that is fitted to the end of the boom. And a control system for controlling the operation of the boom and the bucket is provided to this construction machine. In order to alleviate the burden upon the operator during loading work, the control system according to this embodiment is provided with a semi-automatic loading function, a portion of the control of which is automated. In the following, the construction machine according to this embodiment will be explained with reference to the drawings, centering upon the control by the control system.

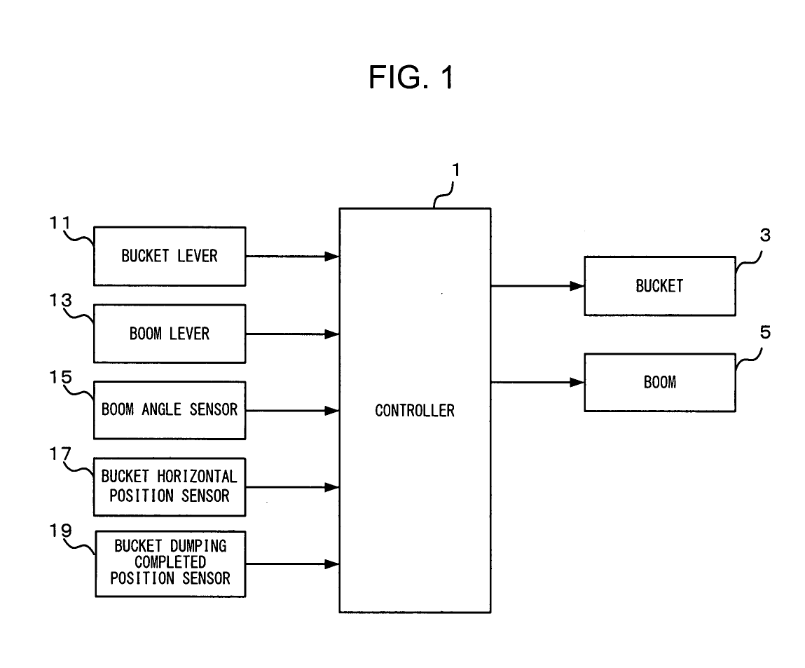

FIG. 1 is a block diagram of the control system that is provided to this construction machine according to an embodiment of the present invention.

This system comprises a controller 1 which controls the operation of a bucket 3 and a boom 5. This controller 1, for example, may control the operation of the bucket 3 and the boom 5 on the basis of the outputs of a bucket lever 11, a boom lever 13, a boom angle sensor 15, a bucket horizontal position sensor 17, and a bucket dumping completed position sensor 19.

The bucket lever 11 is a lever that the operator actuates in order to command the bucket 3 to be operated. This bucket lever 11, for example, may be a lever that shifts along a single axial line, and that can be set to a plurality of positions. This plurality of positions may be, for example, a tilt position that causes the bucket 3 to be tilted, a dump position that causes the bucket 3 to be dumped, and a neutral position that causes the operation of the bucket 3 to be stopped.

And the controller 1 detects the position of the bucket lever 11, and controls the bucket 3 according to this position. In other words, the controller 1 performs control so as: to operate the bucket 3 so as to tilt it, if the bucket lever 11 is in the tilt position; to operate the bucket 3 so as to dump it, if the bucket lever 11 is in the dump position; and so as to stop the operation of the bucket 3, if the bucket lever 11 is in the neutral position.

Now, with the semi-automatic loading function according to this embodiment, the bucket lever 11 is not used. In other words, both dumping and tilting of the bucket 3 are performed with only the boom lever 13. The details of this semi-automatic loading function will be described hereinafter.

The boom lever 13 is a lever that the operator actuates in order to command the boom 5 to be operated. This boom lever 13 also, for example, may be a lever that shifts along a single axial line, and that can be set to a plurality of positions. This plurality of positions may be, for example, an elevating position that causes the boom 5 to be elevated, a lowering position that causes the boom 5 to be lowered, and a neutral position that causes the operation of the boom 5 to be stopped.

And the controller 1 detects the position of the boom lever 13, and controls the boom 5 according to this position. In other words, the controller 1 performs control so as: to cause the boom 5 to be elevated, if the boom lever 13 is in the elevating position; to cause the boom 5 to be lowered, if the boom lever 13 is in the lowering position; and so as to stop the operation of the boom 5, if the boom lever 13 is in the neutral position.

With the semi-automatic loading function, the controller 1 causes the bucket 3 to be operated when the boom lever 13 receives predetermined actuation in specified conditions. This semi-automatic loading function will be described hereinafter.

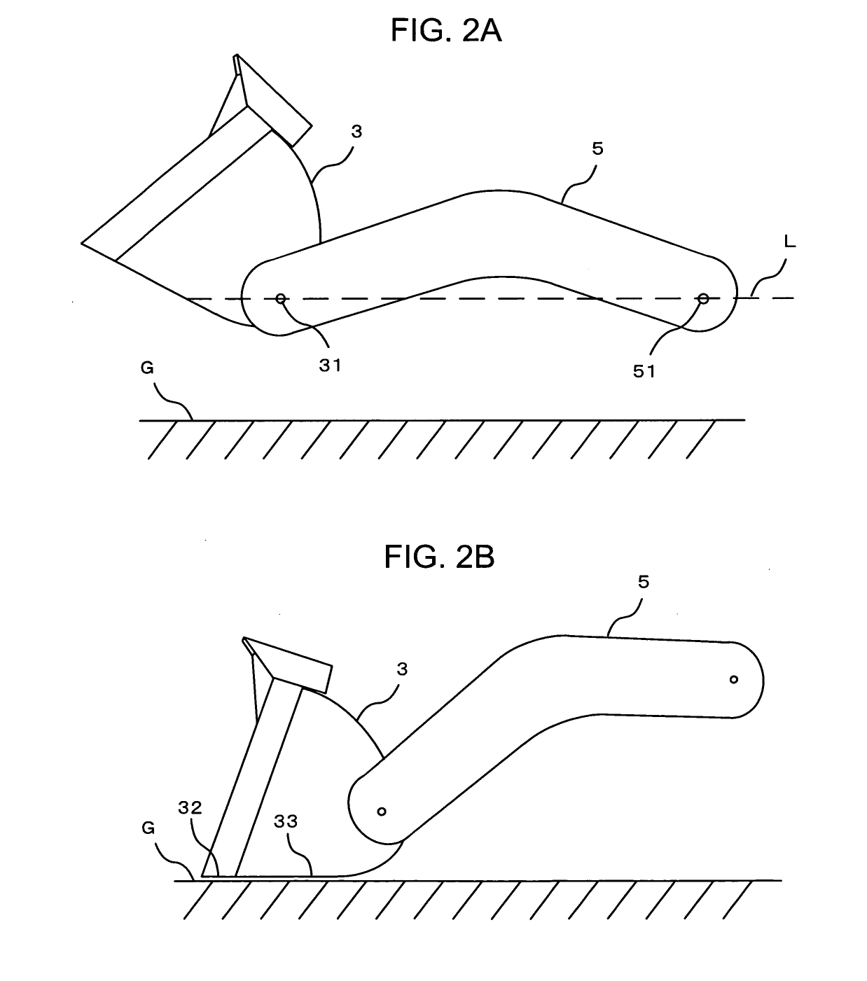

The boom angle sensor 15 is a sensor for detecting the angle of the boom 5 with respect to the horizontal. For example, the controller 1 may detect the angle of the boom 5 on the basis of the output of this boom angle sensor 15. FIG. 2 is a figure showing the positional relationship of the boom 5 and the bucket 3 with relation to the ground surface (the horizontal plane). The angle of the boom 5 that is detected by the boom angle sensor 15 is 0° if, for example, as shown in FIG. 2A, the orientation of the boom 5 is horizontal, in other words if the virtual line L that joins a boom support pin 51 and a bucket support pin 31 is horizontal. And if the end of the boom 5 is raised higher than the horizontal position shown in FIG. 2A, then the boom angle is positive; while if it is dropped lower, then the boom angle is negative.

The bucket horizontal position sensor 17 is a sensor for detecting that the bucket 3 is in the horizontal position. Here the position of the bucket 3 being horizontal is a position in which, as shown for example in FIG. 2B, in the ground contacting state, the orientation of the blade tip 32 of the bucket 3 becomes horizontal upon the ground surface G, or in which the bottom surface 33 of the bucket 3 becomes horizontal. The bucket horizontal position sensor 17 may, for example, be a sensor or a proximity switch that detects the stroke of a cylinder. The controller 1 detects that the bucket 3 is oriented horizontally on the basis of the output of this bucket horizontal position sensor 17. Moreover, instead of being a sensor that directly detects that the bucket is horizontal as described above, the bucket horizontal position sensor 17 could also be a sensor (a bucket angle sensor) that detects its angle relative to the boom. In this case, the controller 1 would detect that the bucket 3 was horizontal on the basis of the outputs of this bucket horizontal position sensor (bucket angle sensor) 17 and of the boom angle sensor 15.

The bucket dumping completed position sensor 19 is a sensor for detecting that the bucket 3 is in the dumping completed position. This bucket dumping completed position sensor 19 may, for example, be a sensor or a proximity switch that detects the stroke of a cylinder. The controller 1 detects that the position of the bucket 3 is the dumping completed position on the basis of the output of this bucket dumping completed position sensor 19. It should be understood that it would also be possible for no such bucket dumping completed position sensor 19 to be provided. In this case, shaking of the bucket 3 as described hereinafter is not performed. Moreover, it would be acceptable for the bucket dumping completed position sensor 19 also to serve as the bucket angle sensor.

It may be arranged to implement each of the functions of the controller 1 explained in the specification of this application, for example, in firmware; or it would also be acceptable to arrange for the controller 1 to be provided with an appropriate processor and memory, and to implement these functions by executing a computer program; and it would also be possible to employ both of the above in combination.

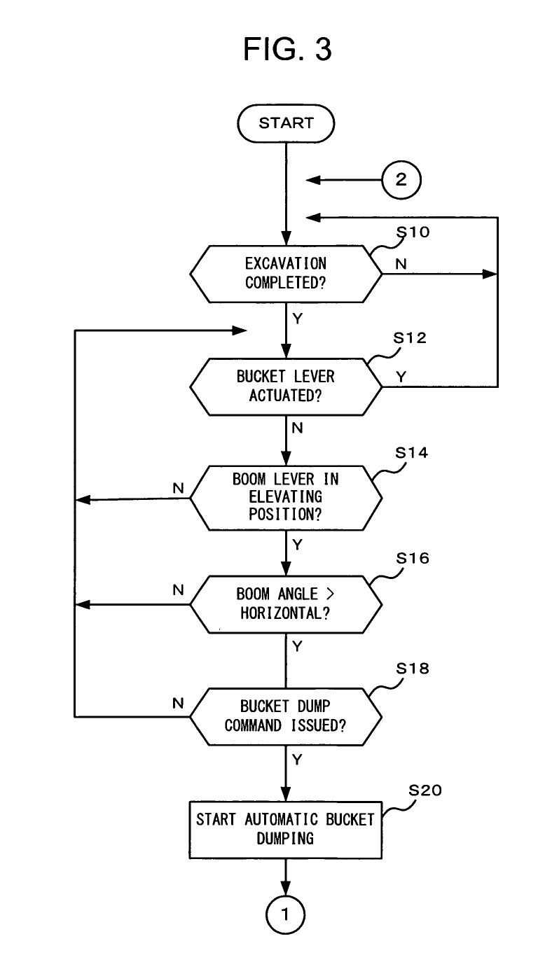

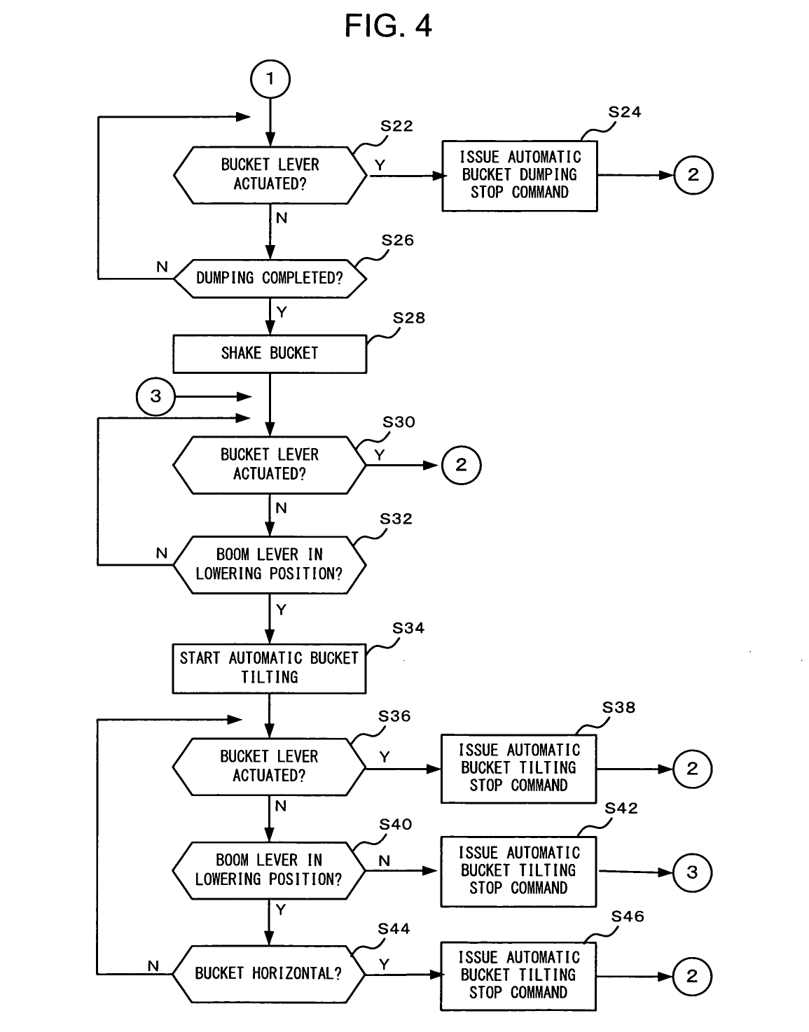

Next, the processing sequence of the semi-automatic loading function according to this embodiment will be explained with reference to FIGS. 3 and 4. The semi-automatic loading function according to this embodiment is a function that controls the bucket 3 and the boom 5, so that the operator is able to perform loading work by only utilizing the boom lever 13.

First, the controller makes a decision as to whether or not excavation work has been completed (a step S10). If excavation work is being performed in the semi-automatic excavation mode, then this decision may, for example, be made according to whether or not, in this semi-automatic excavation mode, it has been decided to terminate excavation. Furthermore, if the semi-automatic excavation mode is not being employed, then it would be acceptable to arrange to determine that excavation has terminated according to some predetermined decision condition that employs the boom angle, the pressure upon the bottom of the boom cylinder, whether or not the gear is reverse or neutral, or the like, or to make this decision on the basis of some predetermined input by the operator.

When the excavation has ended (YES in the step S10), the controller 1 decides whether or not the bucket lever 11 has been actuated, and the flow of control returns to the step S10 if it has been actuated (a step S12). This is because semi-automatic loading is not being performed if the bucket lever 11 has been actuated, since the bucket lever 11 is not employed in this semi-automatic loading.

When the bucket lever 11 is not being actuated (NO in the step S12), a decision is made as to whether or not the boom lever 13 is in the elevating position (a step S14). And when the boom lever 13 is not in the elevating position (NO in the step S14), then the flow of control returns to the step S12. On the other hand, if the boom lever 13 is in the elevating position (YES in the step S14), then, on the basis of the output of the boom angle sensor 15, the controller 1 makes a decision as to whether or not the boom 5 is being raised higher than horizontal (a step S16).

When the boom 5 is not raised higher than the horizontal (NO in the step S16), then the flow of control returns to the step S12. On the other hand, when the boom 5 is raised higher than the horizontal (YES in the step S16), then the controller 1 makes a decision as to whether or not predetermined actuation of the boom lever 13 for issuing a dump command has been performed (a step S18).

Here, with the position for maximum elevation of the boom lever 13 being A and its neutral position being B, the predetermined actuation for issuing a dump command may, for example, be actuation so that the boom lever 13 shifts A→B→A during a short time period (for example 0.5 seconds). It should be understood that it would also be acceptable to arrange for the neutral position B to be its precise neutral position, and a range within ±10% of the stroke of the lever from that position. This actuation for issuing a dump command is only an example; it would also be acceptable for it to be some other type of actuation, provided that it can be received by the boom lever 13. For example, it would be acceptable to provide a button upon the boom lever 13, and for this actuation to be an operation that is received by this button.

When actuation to issue a dump command has not been detected (NO in the step S18), then the flow of control returns to the step S12. On the other hand, when actuation to issue a dump command has been detected (YES in the step S18), then the controller 1 starts the operation of dumping the bucket 3 (automatic bucket dumping) (a step S20). In other words, when the operation with the boom lever 13 to issue a dump command has been detected, the controller 1 dumps the bucket 3, irrespective of whether or not any actuation with the bucket lever 11 has been performed.

Due to this, the operator is able to dump the bucket 3 at a timing which he himself intends, simply by appropriately actuating the boom lever 13.

While automatic dumping of the bucket 3 is being performed, the controller 1 makes a decision as to whether or not the bucket lever 11 has been actuated (a step S22). And if the bucket lever 11 has been actuated (YES in the step S22), the dumping operation that is currently being performed is stopped, and the flow of control returns to the step S10 (a step S24). This is in order to terminate semi-automatic loading if the bucket lever 11, which is not otherwise used in semi-automatic loading, has been actuated.

When actuation of the bucket lever 11 has not been detected (NO in the step S22), the controller 1 makes a decision as to whether or not the bucket has arrived at the dumping completed position (a step S26). If the bucket has not reached dumping completed (NO in the step S26), then the step S22 and subsequent steps are repeated. On the other hand, if the bucket has arrived at the dumping completed position (YES in the step S26), then the controller 1 performs shaking of the bucket 3 several times (a step S28). This shaking of the bucket 3 is a process of shifting the bucket 3 to and fro between a position in which it is slightly tilted from the dumping completed position, and the dumping completed position. By doing this, any remaining soil stuck to the interior of the bucket 3 may be discharged.

After shaking the bucket 3, the controller 1 makes a decision as to whether or not the bucket lever 11 has been actuated (a step S30). And if the bucket lever 11 has been actuated (YES in the step S30), then the flow of control returns to the step S10. This is in order to terminate the semi-automatic loading if the bucket lever 11, which is not used in semi-automatic loading, has been actuated.

And, if actuation of the bucket lever 11 has not been detected (NO in the step S30), then the controller 1 makes a decision as to whether or not the boom lever 13 is in its lowering position (a step S32). When the boom lever 13 is not in its lowering position (NO in the step S32), then the flow of control returns to the step S30.

When the boom lever 13 is in its lowering position (YES in the step S32), then the controller 1, along with lowering the boom 5, also starts tilting operation of the bucket 3 (automatic bucket tilting) (a step S34).

While automatic tilting of the bucket 3 is being performed, the controller 1 makes a decision as to whether or not the bucket lever 11 has been actuated (a step S36). And if the bucket lever 11 has been actuated (YES in the step S36), then the controller 1 stops the lowering of the boom 5 and the tilting operation of the bucket 5 that are currently being performed (a step S38), and then the flow of control returns to the step S10. This is in order to terminate the semi-automatic loading if the bucket lever 11, which is not used in semi-automatic loading, has been actuated.

When no actuation of the bucket lever 11 is detected (NO in the step S36), then the controller 1 makes a decision as to whether or not the boom lever 13 is in its lowering position (a step S40). When the boom lever 13 is not in its lowering position (NO in the step S40), then the lowering of the boom 5 and the tilting operation of the bucket 5 that are currently being performed are stopped (a step S42), and then the flow of control returns to the step S30. This is because, when the boom lever 13 is not in its lowering position, it is considered that this is a time when the operator wishes to stop the lowering of the boom 5 and the tilting operation of the bucket 5. Accordingly, at this time, the movement of the boom 5 and the movement of the bucket 3 are paused, and the flow of control returns to the step S30, so as to start the automatic bucket tilting when for a second time the boom lever 13 reaches the lowering position.

When the boom lever 13 is still in its lowering position (YES in the step S40), then, on the basis of the output of the bucket horizontal position sensor 17, the controller 1 makes a decision as to whether or not the bucket 3 is horizontal (a step S44). While the bucket 3 is not horizontal (NO in the step S44), the flow of control returns to the step S36. And, when the bucket 3 becomes horizontal (YES in the step S44), then the controller 1 stops the lowering of the boom 5 and the tilting operation of the bucket 5 that are currently being performed, and terminates semi-automatic loading (a step S46). In other words, at this time, the bucket 3 has become horizontal, and this construction machine has reached a state it is possible to start the next excavation task.

Since, according to this semi-automatic loading function, by actuating only the boom lever, it is possible for the operator to perform dumping of the bucket as well, accordingly it is possible to alleviate the burden upon the operator of lever actuation during loading work.

The embodiment of the present invention described above is only given as an example for explanation of the present invention; and the range of the present invention is not to be considered as being limited only to the scope of that embodiment. A person skilled in the art will be able to implement the present invention in various other different ways, without deviation from the gist of the present invention.

1. A construction machine comprising a boom and a bucket fitted to said boom, and comprising:
a boom operation lever that can be positioned to a position that commands elevation of said boom, a position that commands lowering thereof, and a position that commands neutral; and
a controller that detects the position of said boom operation lever, and controls said boom and said bucket according to this detected position;
wherein while causing said boom to be elevated, when said controller has detected that a predetermined actuation of said boom operation lever has been performed, then said controller performs control so as to cause said bucket to be dumped.

2. A construction machine according to claim 1, wherein, after having caused said bucket to be dumped, when said controller detects that said boom operation lever has been actuated to said position that commands lowering of said boom, then said controller performs control so as to cause said bucket to be tilted.

3. A construction machine according to claim 1,
further comprising a bucket operation lever that can be positioned to a position that commands tilting of said bucket, a position that commands dumping thereof, and a position that commands neutral;
wherein said controller detects the position of said bucket operation lever and controls said bucket according to this detected position, and, while control of said bucket is being performed on the basis of actuation of said boom operation lever, when said controller has detected that said bucket operation lever has been actuated, said controller stops the control of said bucket on the basis of actuation of said boom operation lever.

4. A construction machine according to claim 1, further comprising a sensor which detects that dumping of said bucket has been completed;
wherein when said controller detects, according to the output of said sensor, that said bucket has reached a dumping completed position, said controller performs control so as to cause said bucket to reciprocate between said dumping completed position and another predetermined position.

5. A construction machine according to claim 2,
further comprising a bucket operation lever that can be positioned to a position that commands tilting of said bucket, a position that commands dumping thereof, and a position that commands neutral;
wherein said controller detects the position of said bucket operation lever and controls said bucket according to this detected position, and, while control of said bucket is being performed on the basis of actuation of said boom operation lever, when said controller has detected that said bucket operation lever has been actuated, said controller stops the control of said bucket on the basis of actuation of said boom operation lever.

6. A construction machine according to claim 2, further comprising a sensor which detects that dumping of said bucket has been completed;
wherein when said controller detects, according to the output of said sensor, that said bucket has reached a dumping completed position, said controller performs control so as to cause said bucket to reciprocate between said dumping completed position and another predetermined position.

7. A construction machine according to claim 3, further comprising a sensor which detects that dumping of said bucket has been completed;
wherein when said controller detects, according to the output of said sensor, that said bucket has reached a dumping completed position, said controller performs control so as to cause said bucket to reciprocate between said dumping completed position and another predetermined position.

8. A construction machine according to claim 4, further comprising a sensor which detects that dumping of said bucket has been completed;
wherein when said controller detects, according to the output of said sensor, that said bucket has reached a dumping completed position, said controller performs control so as to cause said bucket to reciprocate between said dumping completed position and another predetermined position.
